(19) United States
(12) Patent Application Publication
(10) Pub. No.: US 2024/0257217 A1
(43) Pub. Date: Aug. 1, 2024

(54) SYSTEM AND METHOD FOR DETERMINING COMPLEMENTARY ITEMS FOR OUTFIT RECOMMENDATION

(71) Applicant: Walmart Apollo, LLC, Bentonville, AR (US)

(72) Inventors: Najmeh Forouzandehmehr, Saratoga, CA (US); Behzad Shahrasbi, San Jose, CA (US); Evren Korpeoglu, San Jose, CA (US); Kannan Achan, Saratoga, CA (US)

(73) Assignee: Walmart Apollo, LLC, Bentonville, AR (US)

(21) Appl. No.: 18/427,501

(22) Filed: Jan. 30, 2024

Related U.S. Application Data
(60) Provisional application No. 63/442,287, filed on Jan. 31, 2023.

(51) Int. Cl. G06Q 30/0601

(52) U.S. Cl. CPC G06Q 30/0631; G06Q 30/0625; G06Q 30/0643

(57) ABSTRACT

A computer-implemented method including determining, based on an anchor item, at least one look template from a plurality of look templates. The at least one look template can include an anchor super product type for the anchor item, one or more remaining non-accessory super product types, and one or more accessory super product types. The method also can include determining one or more respective complementary items for the anchor item in each of the one or more remaining non-accessory super product types to generate one or more preliminary looks. The method additionally can include determining, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks. The method further can include transmitting, via a computer network, the one or more looks to be displayed on a user interface for a user. Other embodiments are described.

### CROSS-REFERENCE TO RELATED APPLICATIONS

This application claims the benefit of U.S. Provisional Application No. 63/442,287, filed Jan. 31, 2023. U.S. Patent Application No. 63/442,287 is incorporated herein by reference in its entirety.

### TECHNICAL FIELD

This disclosure relates generally to determining complementary items for outfit recommendation.

### BACKGROUND

Modern online retailers often offer a high variety of choices to the users. Recommendation systems are often used to guide users to effectively discover items they seek. Recommending items to users in the apparel space can be significantly different from other spaces. For example, if a user has selected an item of clothing, determining what other items of clothing to recommend can present challenges.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for determining complementary items for outfit recommendations based on an anchor item, according to an embodiment; and

FIG. 4 illustrates a flow chart for a method of determining complementary items for outfit recommendation based on an anchor item, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, ten seconds, thirty seconds, one minute, five minutes, ten minutes, etc.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

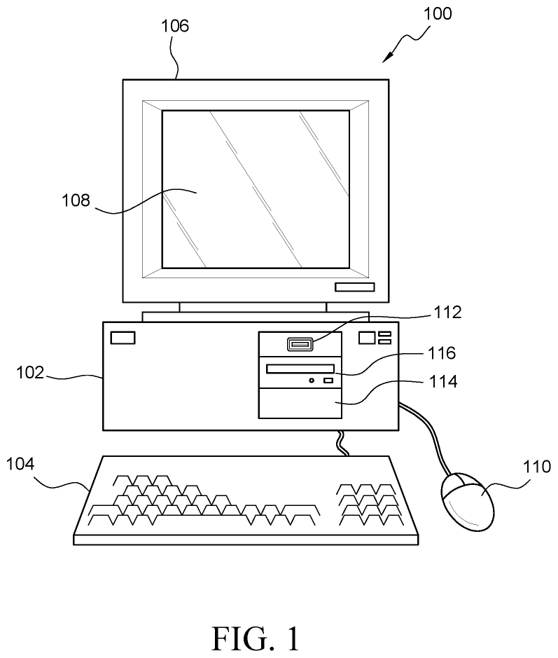

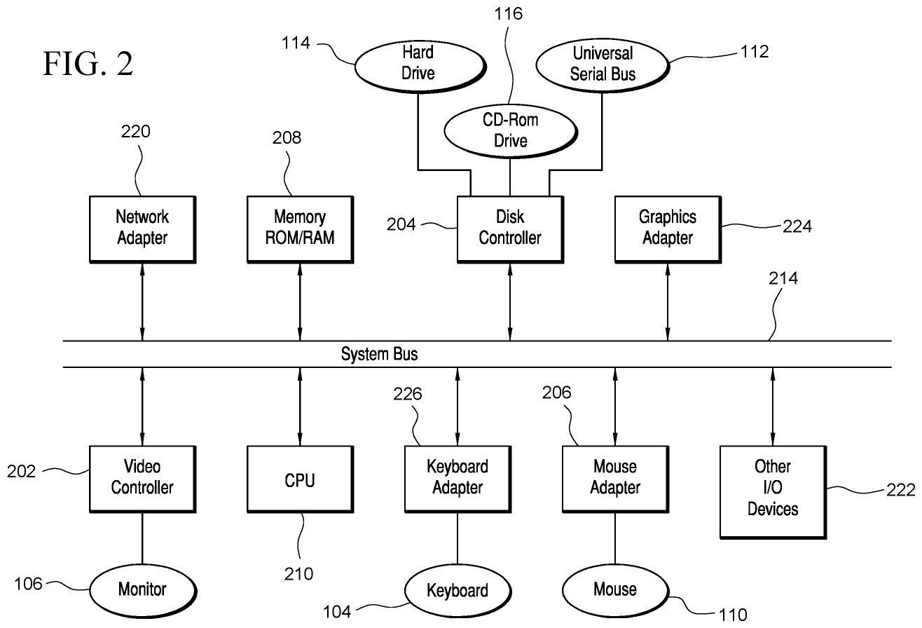

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

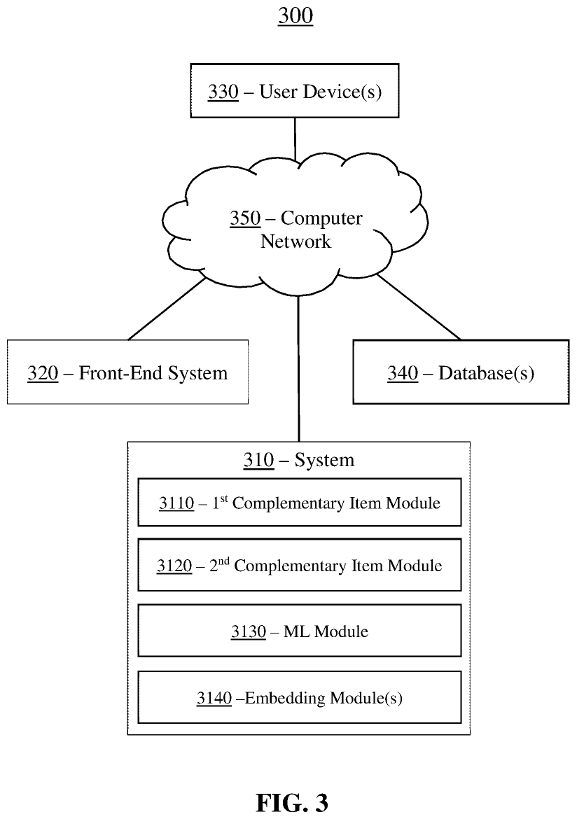

Turning ahead in the drawings, FIG. 3 illustrates a block diagram of a system 300 that can be employed for determining complementary items for outfit recommendations based on an anchor item, according to an embodiment. An exemplary anchor item can be an item whose product page on an online retailer website is about to be displayed, and the product page of the anchor item can include a region (e.g., a column or a block on a webpage) or a hyperlink to a new page for displaying the outfit recommendations. In various embodiments, the complementary items can be determined based on look templates. The look templates can be downloaded or extracted from a public fashion catalog (e.g., Polyvore's catalog, etc.), provided by fashion professionals hired by a retailer or vendors, and so forth. In some embodiments, each look template can include a predefined set of super product types with similar functions (e.g., work apparel, casual apparel, cocktail wedding attire, etc.). In many embodiments, a product type can be a hierarchical classification of items, and a super product type is an abstract layer on top of product types. Each super product type can include multiple product types, and some super product types can overlap. For example, a super product type, casual tops, can include t-shirts, tank tops, gym tops, camp shirts, hooded sweaters, etc., and some of the product types (e.g., hooded sweaters) also can be in another super product type(s) (e.g., sweaters). In several embodiments, super product types can be categorized into multiple groups, such as accessory super product types (e.g., handbags, shoes, jewelries, etc.) and non-accessory super product types (e.g., tops, bottoms, outerwear, etc.).

The number of super product types for a look template can be fixed (e.g., 3-6) or vary according to the functions of the look templates, etc. An exemplary look template can include 5 super product types: casual tops, casual bottoms, denim jackets, sport shoes, and caps. Another exemplary look template can include 4 super product types: women's evening dresses, high heels, handbags, and fine jewelries. In certain embodiments, the predefined set of super product types for a look template further can be refined to a respective predefined set of product types. For example, a look template can include t-shirts, jeans, sport shoes, sunglasses, and baseball caps, or suit jacket, dress shirt, dress pants, dress shoes, and dress belts.

System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can determine the complementary items for an anchor item by: (a) determining at least one look template for the anchor item; (b) selecting candidates from non-accessory super product types of each look template to generate at least one preliminary look; and (c) matching at least one accessory for each of each preliminary look to generate at least one look. System 300 can use similar or different approaches or models to determine the non-accessory complementary items and accessory complementary items. In several embodiments, system 300 further can refine the look(s) by look permutation, ranking, and/or confirming size variants based on inventory, etc. In a number of embodiments, system 300 also can receive feedback from user surveys, user impressions, and/or transaction data about looks that are generated based on look templates and act accordingly (e.g., updating the priority of the look template(s), removing unpopular look templates, etc.).

In some embodiments, system 300 can include a system 310, a front-end system 320, a user device(s) 330, and/or a database(s) 340. System 310 further can include one or more elements, modules, or systems, such as a 1st complementary item module 3110 (FIG. 3), a 2nd complementary item module 3120 (FIG. 3), an ML module 3130 (FIG. 3)), and/or one or more embedding module(s) 3140 (FIG. 3) trained or configured to perform various procedures, processes, and/or activities of system 300 and/or system 310. System 310, front-end system 320, user device(s), 1st complementary item module 3110 (FIG. 3), 2nd complementary item module 3120 (FIG. 3), ML module 3130 (FIG. 3)), and/or embedding module(s) 3140 (FIG. 3) can each be a computer system, such as computer system 100 (FIG. 1), as described above, and can each be a single computer, a single server, or a cluster or collection of computers or servers, or a cloud of computers or servers. In another embodiment, a single computer system can host system 310, front-end system 320, user device(s) 330, 1st complementary item module 3110 (FIG. 3), 2nd complementary item module 3120 (FIG. 3), ML module 3130 (FIG. 3)), and/or embedding module(s) 3140 (FIG. 3). Additional details regarding system 310, front-end system 320, user device(s) 330, 1st complementary item module 3110 (FIG. 3), 2nd complementary item module 3120 (FIG. 3), ML module 3130 (FIG. 3)), and/or embedding module(s) 3140 (FIG. 3) are described herein.

In some embodiments, system 310 can be in data communication with front-end system 320 and/or user device(s) 330, using a computer network (e.g., computer network 350), such as the Internet and/or an internal network that is not open to the public. In a number of embodiments, front-end system 320 can host one or more websites and/or mobile application servers that interface with an application (e.g., a mobile application, a web browser, or a chat application) on a computer device (e.g., user device(s) 330) for a consumer. In other examples, front-end system 320 further can support back-office applications, including receiving inputs from user device(s) 330, managing orders, item listings, inventory, and/or supply, and/or processing payments, etc.

Meanwhile, in many embodiments, system 310 also can be configured to communicate with and/or include a database(s) 340. In some embodiments, database(s) 340 can include a product catalog of a retailer that contains information about products, items, product types, vendors, or SKUs (stock keeping units), for example, among other data as described herein. In several embodiments, database(s) 340 can include product type metadata, super product type metadata, and/or look templates for generating outfit looks for an anchor item. In another example, database(s) 340 further can include training data (e.g., a crowd-curated catalog of fashion outfits, outfits provided by vendors, etc.) and/or hyper-parameters for training and/or configuring system 310, 1st complementary item module 3110 (FIG. 3), 2nd complementary item module 3120 (FIG. 3), ML module 3130 (FIG. 3)), and/or embedding module(s) 3140 (FIG. 3). In yet another example, database(s) 340 also can include data associated with consumers, historical consumer transactions, and/or statistics or analysis performed for the historical consumer transactions.

In a number of embodiments, database(s) 340 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 340 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, communication between system 310, front-end system 320, user device(s) 330, and/or database(s) 340 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can determine, based on an anchor item (e.g., a pair of men's classic-fit dress pants of a brand, etc.), at least one look template from a plurality of look templates. The at least one look template can include an anchor super product type (e.g., men's dress pants, women's sport tops, boy's shoes, etc.) for the anchor item, one or more remaining non-accessory super product types, and one or more accessory super product types. The anchor super product type can be one of the non-accessory super product types or the accessory super product types.

In a number of embodiments, system 310 further can determine one or more respective complementary items for the anchor item in each of the one or more remaining non-accessory super product types to generate one or more preliminary looks. For example, when an anchor item is a women's swimsuit top and the look template for this anchor item includes 5 super product types: women's swimsuit tops, swimsuit bottoms, swimsuit covers, sandals, and sunglasses, system 310 can determine respective complementary items in each of the 3 remaining non-accessory super product types: swimsuit bottoms, swimsuit covers, and sandals.

In some embodiments, system 310 can determine the one or more respective complementary items for the anchor item in each of the one or more remaining non-accessory super product types based on multiple algorithms. For example, determining the one or more respective complementary items for the anchor item in each of the one or more remaining non-accessory super product types further can include: (a) determining, by any suitable first algorithms, models, modules, or systems (e.g., 1st complementary item module 3110), one or more first respective complementary items for the anchor item in each of the one or more remaining non-accessory super product types based on a respective graph-based similarity between the anchor item and each of the one or more first respective complementary items; and (b) determining, by any suitable second algorithms, models, modules, or systems (e.g., 2nd complementary item module 3120), one or more second respective complementary items for the anchor item in each of the one or more remaining non-accessory super product types based on a respective co-purchase signal (and/or co-view signals) between the anchor item and each of the one or more second respective complementary items.

In a number of embodiments, determining the one or more first respective complementary items for the anchor item further can include: (a) determining an anchor image embedding for an anchor item image of the anchor item; (b) determining a first respective image embedding for a first respective image of each of the one or more first respective complementary items; and (c) determining the respective graph-based similarity based on a distance (e.g., cosine similarity, Euclidean distance, etc.) between the anchor image embedding and the first respective image embedding. As an example, and U.S. patent application Ser. No. 16/722,467, filed Dec. 20, 2019, issued as U.S. patent Ser. No. 17/191,358 on Sep. 27, 2022, which is incorporated herein by this reference in its entirety, describes an exemplary first complementary item algorithm.

Further, in several embodiments, the graph-based similarity for each of the one or more first respective complementary items alternatively or additionally can include a respective rank (e.g., a ranking based on a respective distance between image embeddings). When the respective distance is shorter, the respective rank can be higher, and the higher the respective rank is, the more related or complementary the items may be. In certain embodiments, system 310 can apply a filter to remove any of the one or more first respective complementary items that is associated with a respective distance greater than a threshold (e.g., an average or medium value of the respective distance, etc.) or a respective rank not on the top (e.g., top 3, 5, 10, etc.).

In many embodiments, determining the one or more second respective complementary items for the anchor item further can include: (a) determining one or more similar items for the anchor item; and (b) determining the one or more second respective complementary items for the anchor item in each of the one or more remaining non-accessory super product types further based on a respective similar-item co-purchase signal between each of the one or more similar items and each of the one or more second respective complementary items. As an example, U.S. patent application Ser. No. 17/589,306, filed Jan. 31, 2022, which is herein incorporated by this reference in its entirety, describes an exemplary second complementary item algorithm.

In a few embodiments, the respective co-purchase signal (and/or co-view signals) between the anchor item and each of the one or more second respective complementary items can be determined based on the count or frequency of historical transactions (and/or sessions) in which the two items were purchased (and/or viewed) together. The more times or more frequent these items were purchased (and/or viewed) together, the more complementary the items may be. In certain embodiments, each of the one or more second respective complementary items can be accepted only if a respective co-purchase or co-view rate is above a second threshold (e.g., 10%, 30%, 50%, etc.). In similar or different embodiments, in order to find the one or more second respective complementary items for an anchor item, system 310 or 2nd complementary item module 3120 can search for co-purchase (or co-view) records with the anchor item from historical data, sort the search results according to the respective co-purchase (or co-view) rate, and then select the top k (e.g., 10, 20, 50, 65, etc.) co-purchased (or co-viewed) non-accessory items as the one or more second respective complementary items.

In many embodiments, system 310 further can combine the results determined from each of the multiple algorithms (e.g., the one or more first respective complementary items and the one or more second respective complementary items) into the one or more respective complementary items, in any suitable manners. For example, in certain embodiments, the one or more respective complementary items can include a union of the one or more first respective complementary items and the one or more second respective complementary items. In some embodiments, every item of the one or more first respective complementary items and the one or more second respective complementary items can be included in the one or more respective complementary items. In a few embodiments, x % (e.g., 30%-70%, etc.) of the one or more respective complementary items can be selected from the top-ranked one or more first respective complementary items and (100-x)% (e.g., 70%-30%, etc.) of the one or more respective complementary items can be selected from the top-ranked one or more second respective complementary items.

System 310 can use an approach or algorithm that is different from those described above for recommending non-accessory items to determine accessory recommendations. In many embodiments, system 310 further can determine, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks. The machine learning module can include any suitable algorithms, models, modules, and/or systems (e.g., ML module 3130 (FIG. 3), bidirectional Long Short-Term Memory (bi-LSTM), Visual-Semantic Embedding (VSE), SiameseNet, SetRNN, backward LSTM (b-LSTM), bi-LSTM and VSE, a multi-head attention model, a transformer-based model, etc.).

The machine learning module (e.g., ML module 3130) can be trained to “fill the blank” by determining at least one candidate accessory item to match one or more existing outfit items of an outfit look. The one or more existing outfit items of the outfit look can include one or more existing non-accessory items and/or one or more existing accessory items. For example, system 310 can use the machine learning module as trained to recommend an accessory item (e.g., a necklace as defined in an outfit look regarding women's work clothes) to match, based on visual compatibility, the existing outfit items (e.g., a women's blouse, a blazer, a skirt, pump shoes, and a handbag) for the outfit look.

In a number of embodiments, system 310 also can include generating training image feature vectors for training item images of training items in a training dataset, based on any suitable algorithms, models, modules, and/or systems. In an exemplary embodiment, system 310 can generate training image feature vectors using any suitable algorithms, models, modules, and/or systems (e.g., an InceptionV3 model, a Contrastive Language-Image Pre-Training (CLIP) image embedding model, etc.). The training items can include items from a public database (e.g., the Polyvore dataset, DeepFashion2 dataset, etc.), a retailer's catalog, curated looks by merchants of a retailer, etc.

In several embodiments, system 310 further can include training the machine learning module (e.g., ML module 3130 (FIG. 3), a VSE (Visual-Semantic Embedding) module, etc.) based on the training image feature vectors for the training item images. The training item images for a training outfit look can be inputted into the machine learning module in a predetermined sequence (e.g., tops, then bottoms, then shoes, then necklaces, and finally handbags) for the training outfit look to recommend an accessory item (e.g., shoes, a necklace, or a handbag) to match one or more existing training outfit items in the training outfit look.

In a few embodiments, training the machine learning module further can include: (a) training a visual-semantic embedding module (e.g., embedding module(s) 3140 (FIG. 3)) based on the training item images and training item texts of the training items to generate visual-semantic embeddings for the training items; and (b) training the machine learning module further based on the visual-semantic embeddings, as generated.

In many embodiments, after the one or more looks for the anchor item are determined, system 310 further can process the one or more looks before transmitting the one or more looks. In a number of embodiments, system 310 further can increase the coverage of the recommendations by any suitable approaches (e.g., item permutations). In several embodiments, after the one or more looks are determined based on the techniques described above, system 310 further can re-determine the one or more looks by: (a) choosing a respective simulation anchor item (which is not the anchor item) from each of the one or more looks; and (b) simulating complementary item determining and accessory determining for the respective simulation anchor item with the anchor item (which is included in the re-determined one or more looks, including existing or possibly one or more new looks, after the complementary item determining and accessory determining). In several embodiments, system 310 can be configured to only perform item permutations when the one or more remaining non-accessory super product types (e.g., tops, bottoms, etc.) further comprise one or more major super product types; and the respective simulation anchor item is selected from the one or more respective complementary items in each of the one or more major super product types (e.g., tops, bottoms, and/or outerwear). In a few embodiments, the one or more major super product types can include some or all of the non-accessory product types.

For example, in certain embodiments, after multiple looks for an anchor item (e.g., t-shirt) are determined by complementary item determining (e.g., using 1st complementary item module 3110 and/or 2nd complementary item module 3120) and accessory determining (e.g., using ML module 3130 and embedding module(s) 3140) for the anchor item, for a look that includes a t-shirt, jeans, and other accessory items, system 310 can run an item permutation by: (a) choosing a jeans as the respective simulation anchor item from the remaining non-accessory super product types (e.g., tops or bottoms); and (b) simulating complementary item determining and accessory determining for the jeans with the anchor item, including (i) receiving results of simulating complementary item determining and accessory determining; (ii) filtering out any of the results that does not include the anchor item, the t-shirt; and (iii) if at least one new look exists in the results, adding the at least new look to the multiple results.

In another example, if a look (Look) generated for a jacket (the original anchor item) by system 310 includes: Look=[jacket, top, leggings, socks, water bottle], the permuted looks can include:
Look-p1=[top, jacket, leggings, socks, water bottle], with the top as a first simulation anchor item; and
Look-p2=[leggings, jacket, top, socks, water bottle], with the leggings as a second simulation anchor item.

In many embodiments, system 310 further can rank the one or more looks based on respective look scores calculated by any suitable formula. System 310 can rank the one or more looks after item permutations, if performed. For example, in some embodiments, the one or more looks for an anchor item can be determined by (a) determining respective non-accessory items for each of the one or more looks multiple models, modules, or systems (e.g., 1st complementary item module 3110 and/or 2nd complementary item module 3120); (b) determining respective accessory items for each of the one or more looks using ML module 3130 based on image embedding for each item by embedding module(s) 3140; (c) after (a) and (b), re-determining the one or more looks by item permutations for each of the one or more looks; and (d) after (c), ranking the one or more looks for the anchor item based on a respective look score (l) for each look (look), calculated based on: (i) the score between each complementary item and the anchor item determined by the multiple models in (a) (e.g., 1st complementary item module 3110 and 2nd complementary item module 3120) and/or (ii) color compatibility between items in each look.

An exemplary formula for determining the look score (l) can be as follows:

$$l = ε m + ( 1 - ε ) ( γ {\sum }_{r ∈ look} {c}_{ar} + ( 1 - γ ) {{\sum }_{r , {r}^{′} ∈ look}}_{r \neq {r}^{′}} {c}_{{rr}^{′}} )$$

m: a mean score of a first score (e.g., a graph-based similarity score) from 1st complementary item module 3110 and a second score (e.g., a co-purchase signal-based score) from 2nd complementary item module 3120;
ε and γ: model constants that can be predefined or learned by any suitable models, modules, or systems (e.g., a logistic regression model trained based on user interactions (e.g., clicks), and/or the lack thereof, with looks previously generated, etc.); and
cᵢⱼ: the respective color score between item i and item j which is derived from a color matrix.

In a few embodiments, the color matrix can be initialized using a predefined color palette. Further, system 310 can update the color matrix based on data overtime as users interact with system 300, system 310, or front-end system 320 (e.g., clicking a hyperlink or a button on a webpage, purchasing an item from system 310, etc.). In addition, color attributes of each item can be preprocessed to be mapped or categorized into a predefined set of major colors (e.g., 18 major colors or 36 major colors, etc.). For example, the colors of navy, cobalt, and indigo blues can be mapped to a major color blue, and the colors of rose, crimson, and candy reds can be mapped to a major color red, etc.

In several embodiments, system 310 further can, after determining and/or re-determining the one or more looks, determine size availability match among respective items of each of the one or more looks based on sizes available for the anchor item. For example, if an anchor item has available sizes of small and large and multiple looks ready to be recommended to a user, system 310 can check whether each non-anchor item of each look has a matching size availability (e.g., small and large). If a non-anchor item of one or more looks of the multiple looks runs out of any matching size (e.g., small or large), system 310 can remove the one or more looks that has this non-anchor item from the final list of looks.

In many embodiments, system 310 can include a feedback loop and update the look templates regularly. In certain embodiments, system 310 can update the plurality of look templates based on impression signals (e.g., click-through rates and/or purchase rates, etc.) associated with historical looks created based on the plurality of look templates. For example, system 310 can remove a look template of the plurality of look templates stored in database 340 when looks created based on this look template in a time period (e.g., the past 6 months, the past year, etc.) produced a low rate of impression signals (e.g., an average purchase rate of the looks being lower than a threshold (e.g., 10%, 20%, or 30% of the average purchase rate of all of the looks created based on the plurality of look templates in the time period)). For example, in some embodiments, system 310 can exclude a look if the look, although transmitted to be displayed on various user devices, does not receive any user interaction after a time period (e.g., 2 months, 3 months, etc.). Further, system 310 can update the order of displaying looks based on user interactions by giving a higher rank (thus displayed on the top or in a position relatively higher) to looks with higher user engagement while giving a lower rank to looks with lower user engagement.

In many embodiments, system 310 can transmit, via a computer network, the one or more looks to be displayed on a user interface for a user. For example, the one or more looks determined and/or re-determined as described above can be transmitted, via computer network 350, to user device 330 and be displayed on an outfit recommendation region of the product webpage for the anchor item.

Meanwhile, in some embodiments, before transmitting the one or more looks to be displayed on the user interface, the system 310 also can automatically determine, offline or in real-time, a respective item image for each item for outfit recommendation to be displayed on the user interface. The item image for outfit recommendation can be stored or tagged in a product catalog (e.g., database 340) for future use in determining outfit recommendation. Further, there can be one or more requirements and/or preferred features for an item image for outfit recommendation. For example, item images with human models (or their hands and/or feet) can be less preferred than item images without human models for outfit recommendation. Item images showing only a part of, not the whole, items can be not ideal either. Further, item images with higher resolutions and/or showing more details can be preferred over other item images for the item.

In many embodiments, determining the item image for an item can include: (a) detecting and filtering out one or more item images of multiple item images for the item that includes a human being, by any suitable object detection algorithms, models, modules, and/or systems (e.g., a light weight You Only Look Once v3 (YOLO v3) model, a Single Shot Multi-Box Detector (SSD) model, a RetinaNet model, a Mask R-CNN model, etc.); and (b) determining, by any suitable image classification algorithms, models, modules, and/or systems (e.g., a ResNet34 model, an Xception model, a Deep Vit model, a T2T-Vit model, etc.), the respective item image based on a score or a ranking for each of the remaining item image(s) of the multiple item images. In some embodiments, the techniques described here also can be used to generate training items for the machine learning module (e.g. ML module 3130 (FIG. 3)).

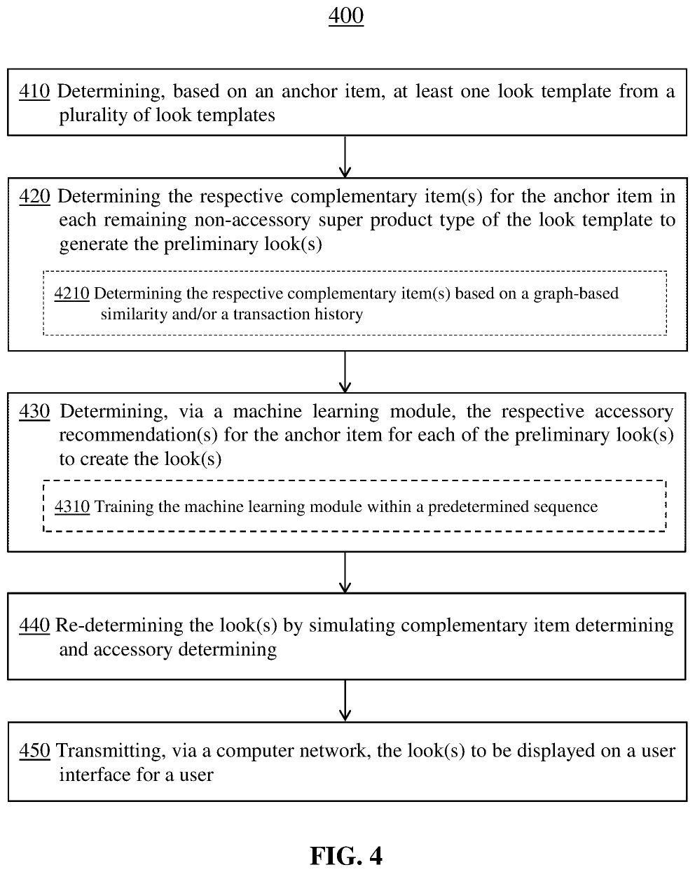

Turning ahead in the drawings, FIG. 4 illustrates a flow chart for a method 400 of determining complementary items for outfit recommendation based on an anchor item, according to an embodiment. Method 400 can be performed in real-time. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) (including one or more of its elements, modules, and/or systems, such as 1st complementary item module 3110 (FIG. 3), 2nd complementary item module 3120 (FIG. 3), ML module 3130 (FIG. 3)), and/or embedding module(s) 3140 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, method 400 can include determining, based on the anchor item (e.g., a pair of khaki pants, a pullover sweater, etc.), at least one look template from a plurality of look templates (activity 410). In many embodiments, each look template can include one or more super product types, including an anchor super product type (e.g., men's pants, women's sweaters, etc.) for the anchor item that is not an accessory super product type and one or more remaining non-accessory super product types. Each look template further can include one or more accessory super product types (e.g., women's shoes, men's belts, sunglasses, etc.). Method 400 can use similar or different approaches to determine the complementary items from different super product types. For example, method 400 can determine the complementary items in non-accessory super product types by techniques different from those for determining the complementary items in accessory super product types.

In many embodiments, method 400 further can include determining one or more respective complementary items for the anchor item in each remaining non-accessory super product type of the look template to generate one or more preliminary looks (activity 420), based on any suitable algorithms, models, modules, and/or systems. Activity 420 further can include determining the one or more respective complementary items based on one or more algorithms, such as a graph-based similarity and/or a transaction history (e.g., historical co-purchase events) between the anchor item and each candidate complementary item (activity 4210).

In a number of embodiments, activity 4210 further can include determining one or more first respective complementary items for the anchor item in each remaining non-accessory super product type of the look template based on a respective graph-based similarity between the anchor item and each first respective complementary item. Two items can be deemed more complementary to each other when the degree of the respective graph-based similarity is greater. In a few embodiments, the degree of the respective graph-based similarity can be measured by a distance between the image embeddings of images for anchor item and each first respective complementary item, and a shorter distance can indicate that the degree of the respective graph-based similarity is greater. In some embodiments, activity 4210 further can determine a first respective score or rank between the anchor item and each first respective complementary item based on the respective graph-based similarity. the In certain embodiments, the more complementary the anchor item and each first respective complementary item is, the greater the first respective score or the higher the first respective rank can be. In similar or different embodiments, the more complementary the anchor item and each first respective complementary item is, the less the first respective score or the lower the first respective rank would be.

Activity 4210 also can include determining one or more second respective complementary items for the anchor item in each remaining non-accessory super product type of the look template based on a respective co-purchase signal (e.g., a respective co-purchase rate) between the anchor item and each second respective complementary item. Two items can be deemed more complementary to each other when the degree of the respective co-purchase signal is greater. In several embodiments, activity 4210 further can determine a second respective score or rank between the anchor item and each second respective complementary item based on the respective co-purchase signal. In a few embodiments, the more complementary the anchor item and each second respective complementary item is, the greater the second respective score or the higher the second respective rank can be. In similar or different embodiments, the more complementary the anchor item and each second respective complementary item is, the less the second respective score or the lower the second respective rank would be.

In some embodiments, activity 4210 further can include the one or more first respective complementary items and the one or more second respective complementary items in the one or more respective complementary items for the anchor item in each remaining non-accessory super product type of the look template. In certain embodiments, activity 4210 can use a threshold for the first respective score or the second respective score or a cap of item count to filter the one or more first respective complementary items and/or the one or more second respective complementary items.

In many embodiments, method 400 additionally can include determining, via a machine learning module (e.g., ML module 3130 (FIG. 3), a bi-LSTM (bidirectional Long Short-Term Memory) model, a SiameseNet model, etc.), at least one accessory recommendation for the anchor item for each preliminary look determined in activity 420 to create one or more looks for outfit recommendation (activity 430). Activity 430 also can include training the machine learning module with a predetermined sequence based on a training dataset (activity 4310). For example, the input for training the machine learning module can be an image feature vector generated by an image encoder (e.g., embedding module(s) 3140 (FIG. 3), a VSE (Visual-Semantic Embedding) module, etc.) for each training item (e.g., a top, a bottom, an accessory item, etc.) of a training outfit look from the training dataset, and the image feature vector for each training item (e.g., a top, a bottom, an accessory item, etc.) of the training outfit look can be inputted into the machine learning module in the predetermined sequence (e.g., top, bottom, shoes, belt, and watch) for training outfit look. In some embodiments, the training outfit looks and/or the training items in the training dataset can be obtained from various sources, such as the Polyvore dataset, a retailer's product catalog, etc.

In some embodiments, the image encoder (e.g., embedding module 3140 (FIG. 3)) for the machine learning module (e.g., ML module 3130 (FIG. 3)) further can include a visual-semantic embedding module, and activity 430 or activity 4310 further can include training the visual-semantic embedding module based on the training item images and training item texts of the training items to generate visual-semantic embeddings for the training items for the machine learning module.

In a number of embodiments, method 400 further can include re-determining the one or more looks, as determined in activities 420 and 430 (activity 440). Activity 440 can include simulating complementary item determining in activity 420 and accessory determining in activity 430 for each look by switching the anchor item with each complementary non-accessory item of each look. By this simulation process in activity 440, new looks not in the original one or more looks may be found, and the coverage of method 400 can expand. In many embodiments, activity 440 further can include ranking the looks using any suitable formula. In several embodiments, activity 440 can rank the looks based on the first respective score and/or the second respective score determined in activity 4210 and/or a color compatibility between items in each look. In a few embodiments, activity 440 further can include determining size availability match among items of each look based on sizes available for the anchor item to ensure that all sizes of the same anchor item have the same look available.

In many embodiments, method 400 further can include transmitting, via a computer network (e.g., computer network 350 (FIG. 3)), the one or more looks to be displayed on a user interface (e.g., a product webpage) for a user (activity 450).

Various embodiments can include a system for determining complementary items for an anchor item to complete one or more looks for outfit recommendation. The system can include one or more processors and one or more non-transitory computer-readable media storing computing instructions that, when run on the one or more processors, cause the one or more processors to perform certain operations. The operations can include determining, based on an anchor item, at least one look template from a plurality of look templates. The at least one look template can include an anchor super product type for the anchor item, one or more remaining non-accessory super product types, and one or more accessory super product types. The operations further can include determining one or more respective complementary items for the anchor item in each of the one or more remaining non-accessory super product types to generate one or more preliminary looks. The operations additionally can include determining, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks. Finally, the operations further can include transmitting, via a computer network, the one or more looks to be displayed on a user interface for a user.

A number of embodiments can include a computer-implemented method. The method can include determining, based on an anchor item, at least one look template from a plurality of look templates. The at least one look template can include an anchor super product type for the anchor item, one or more remaining non-accessory super product types, and one or more accessory super product types. The method also can include determining one or more respective complementary items for the anchor item in each of the one or more remaining non-accessory super product types to generate one or more preliminary looks. The method additionally can include determining, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks. The method further can include transmitting, via a computer network, the one or more looks to be displayed on a user interface for a user.

In many embodiments, the techniques described herein can provide a practical application and several technological improvements. The techniques described herein can provide outfit recommendations based on multiple complementary item recommendation modules, including the machine learning module trained, according to the super product type for each candidate complementary item. These techniques can provide a significant improvement over conventional outfit recommendation approaches that use a single model to recommend items of different product types for a look. The techniques described herein also can provide technical improvements by providing a unconventional way to train the machine learning module to determine accessory complementary item recommendation. Further, techniques described herein can provide technical improvements by automatically determining the item image from multiple images for presenting for an outfit recommendation.

Although determining complementary items for an anchor item for outfit recommendation has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the modules, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising one or more processors and one or more non-transitory computer-readable media storing computing instructions that, when executed on the one or more processors, cause the one or more processors to perform operations comprising:
determining, based on an anchor item, at least one look template from a plurality of look templates, wherein the at least one look template comprises an anchor super product type for the anchor item, one or more remaining non-accessory super product types, and one or more accessory super product types;
determining one or more respective complementary items for the anchor item in each of the one or more remaining non-accessory super product types to generate one or more preliminary looks;
determining, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks; and
transmitting, via a computer network, the one or more looks to be displayed on a user interface for a user.

2. The system of claim 1, wherein:
determining the one or more respective complementary items for the anchor item in each of the one or more remaining non-accessory super product types is based on multiple algorithms.

3. The system of claim 2, wherein:
determining the one or more respective complementary items for the anchor item in each of the one or more remaining non-accessory super product types further comprises:
determining one or more first respective complementary items for the anchor item in each of the one or more remaining non-accessory super product types based on a respective graph-based similarity between the anchor item and each of the one or more first respective complementary items; and
determining one or more second respective complementary items for the anchor item in each of the one or more remaining non-accessory super product types based on a respective co-purchase signal between the anchor item and each of the one or more second respective complementary items; and
the one or more respective complementary items comprise a union of the one or more first respective complementary items and the one or more second respective complementary items.

4. The system of claim 3, wherein:
determining the one or more first respective complementary items for the anchor item further comprises:
determining an anchor image embedding for an anchor item image of the anchor item;
determining a first respective image embedding for a first respective image of each of the one or more first respective complementary items; and
determining the respective graph-based similarity based on a distance between the anchor image embedding and the first respective image embedding.

5. The system of claim 3, wherein:
determining the one or more second respective complementary items for the anchor item further comprises:
determining one or more similar items for the anchor item; and
determining the one or more second respective complementary items for the anchor item in each of the one or more remaining non-accessory super product types further based on a respective similar-item co-purchase signal between each of the one or more similar items and each of the one or more second respective complementary items.

6. The system of claim 1, wherein the operations further comprise:
generating training image feature vectors for training item images of training items in a training dataset; and
training the machine learning module based on the training image feature vectors for the training item images inputted into the machine learning module in a predetermined sequence to recommend an accessory item to match one or more existing outfit items of an outfit look.

7. The system of claim 6, wherein:
training the machine learning module further comprises:
training a visual-semantic embedding module based on the training item images and training item texts of the training items to generate visual-semantic embeddings for the training items; and
training the machine learning module further based on the visual-semantic embeddings, as generated.

8. The system of claim 1, wherein the operations further comprise:
after the one or more looks are created, re-determining the one or more looks by:
choosing a respective simulation anchor item from each of the one or more looks; and
simulating complementary item determining and accessory determining for the respective simulation anchor item with the anchor item, wherein the one or more remaining non-accessory super product types further comprise one or more major super product types, and the respective simulation anchor item is selected from the one or more respective complementary items in each of the one or more major super product types.

9. The system of claim 8, wherein the operations further comprise one or more of:
after re-determining the one or more looks, ranking the one or more looks based on a color matrix;
after re-determining the one or more looks, determining size availability match among respective items of each of the one or more looks based on sizes available for the anchor item; or
updating the plurality of look templates based on impression signals associated with historical looks created based on the plurality of look templates.

10. The system of claim 1, wherein the operations further comprise one or more of:
after the one or more looks are created, ranking the one or more looks based on a color matrix;
after the one or more looks are created, determining size availability match among respective items of each of the one or more looks based on sizes available for the anchor item; or
updating the plurality of look templates based on impression signals associated with historical looks created based on the plurality of look templates.

11. A computer-implemented method comprising:
determining, based on an anchor item, at least one look template from a plurality of look templates, wherein the at least one look template comprises an anchor super product type for the anchor item, one or more remaining non-accessory super product types, and one or more accessory super product types;
determining one or more respective complementary items for the anchor item in each of the one or more remaining non-accessory super product types to generate one or more preliminary looks;
determining, via a machine learning module, at least one respective accessory recommendation for the anchor item for each of the one or more preliminary looks based at least in part on respective visual compatibility of the at least one respective accessory recommendation with respective existing items of each of the one or more preliminary looks to create one or more looks; and
transmitting, via a computer network, the one or more looks to be displayed on a user interface for a user.

12. The computer-implemented method of claim 11, wherein:
determining the one or more respective complementary items for the anchor item in each of the one or more remaining non-accessory super product types is based on multiple algorithms.

13. The computer-implemented method of claim 12, wherein:
determining the one or more respective complementary items for the anchor item in each of the one or more remaining non-accessory super product types further comprises:
determining one or more first respective complementary items for the anchor item in each of the one or more remaining non-accessory super product types based on a respective graph-based similarity between the anchor item and each of the one or more first respective complementary items; and
determining one or more second respective complementary items for the anchor item in each of the one or more remaining non-accessory super product types based on a respective co-purchase signal between the anchor item and each of the one or more second respective complementary items; and
the one or more respective complementary items comprise a union of the one or more first respective complementary items and the one or more second respective complementary items.

14. The computer-implemented method of claim 13, wherein:
determining the one or more first respective complementary items for the anchor item further comprises:
determining an anchor image embedding for an anchor item image of the anchor item;
determining a first respective image embedding for a first respective image of each of the one or more first respective complementary items; and
determining the respective graph-based similarity based on a distance between the anchor image embedding and the first respective image embedding.

15. The computer-implemented method of claim 13, wherein:
determining the one or more second respective complementary items for the anchor item further comprises:
determining one or more similar items for the anchor item; and
determining the one or more second respective complementary items for the anchor item in each of the one or more remaining non-accessory super product types further based on a respective similar-item co-purchase signal between each of the one or more similar items and each of the one or more second respective complementary items.

16. The computer-implemented method of claim 11 further comprising:
generating training image feature vectors for training item images of training items in a training dataset; and
training the machine learning module based on the training image feature vectors for the training item images inputted into the machine learning module in a predetermined sequence to recommend an accessory item to match one or more existing outfit items of an outfit look.

17. The computer-implemented method of claim 16, wherein:
training the machine learning module further comprises:
training a visual-semantic embedding module based on the training item images and training item texts of the training items to generate visual-semantic embeddings for the training items; and
training the machine learning module further based on the visual-semantic embeddings, as generated.

18. The computer-implemented method of claim 11 further comprising:
after the one or more looks are created, re-determining the one or more looks by:
choosing a respective simulation anchor item from each of the one or more looks; and
simulating complementary item determining and accessory determining for the respective simulation anchor item with the anchor item, wherein the one or more remaining non-accessory super product types further comprise one or more major super product types, and the respective simulation anchor item is selected from the one or more respective complementary items in each of the one or more major super product types.

19. The computer-implemented method of claim 18 further comprising one or more of:
after re-determining the one or more looks, ranking the one or more looks based on a color matrix;
after re-determining the one or more looks, determining size availability match among respective items of each of the one or more looks based on sizes available for the anchor item; or
updating the plurality of look templates based on impression signals associated with historical looks created based on the plurality of look templates.

20. The computer-implemented method of claim 11 further comprising one or more of:
after the one or more looks are created, ranking the one or more looks based on a color matrix;
after the one or more looks are created, determining size availability match among respective items of each of the one or more looks based on sizes available for the anchor item; or
updating the plurality of look templates based on impression signals associated with historical looks created based on the plurality of look templates.
